(19) United States
(12) Patent Application Publication
(10) Pub. No.: US 2006/0123225 A1
(43) Pub. Date: Jun. 8, 2006

(54) Method and system for decryption of encrypted packets

(75) Inventors: Abhishek Sharma, Streamwood, IL (US); Arun Alex, Bartlett, IL (US); Sudhir Kunnath, Bolingbrook, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTStarcom, Inc., Alameda, CA (US)

(21) Appl. No.: 11/003,546

(22) Filed: Dec. 3, 2004

(51) Int. Cl. G06F 15/16; H04L 9/00; G06F 17/00; G06F 9/00

(52) U.S. Cl. 713/153; 726/13

(57) ABSTRACT

A method of processing data packets in a data network. The method includes receiving an encrypted data packet at a packet switch. The packet switch determines a packet-processing device for decrypting the encrypted data packet and communicates the encrypted data packet to the first packet-processing device. The first packet-processing device decrypts the encrypted data packet a clear data packet. The packet-processing device then communicates the clear data back to the packet switch for continued processing.

### CROSS REFERENCE TO RELATED APPLICATIONS

This application is related to commonly assigned, co-pending U.S. patent application Ser. No. ______, filed on ______ and entitled “Method and System for Providing Packet Data Services” and Ser. No. ______, filed on ______ and entitled “Method and System for Load Balancing in Network Platform”, both to the same inventors as the instant application. The disclosures of U.S. patent application Ser. Nos. ______ and ______ are incorporated herein by reference in their entirety.

### BACKGROUND

I. Field

This invention is related to data communications and, more specifically, to systems and methods for processing encrypted data packets in a data network.

II. Description of Related Art

The use of technology for accessing the Internet, the World Wide Web and/or other types of packet data networks (e.g., business or private networks) continues to increase at a rapid rate. The advent of wireless mobile devices, such as wireless phones, wireless personal digital assistants (PDAs) and wireless network enabled notebook computers, provides users of such devices with the ability to access data networks from any location where radio coverage facilitating such access is available. Further, the use of Virtual Private Networks allows computer users to access private networks from publicly accessible networks, such as through an Internet Service Provider's network or a publicly accessible wireless data network (e.g., the Sprint PCS network) using the Mobile Internet Protocol (IP). Virtual Private Networking is described in further detail in U.S. Pat. No. 6,816,912 to Borella et al., issued Nov. 9, 2004, assigned to the assignee of the instant application. U.S. Pat. No. 6,816,912 is incorporated herein by reference in its entirety. Further, Mobile IP functions may be implemented in accordance with the Code Division Multiple Access (CDMA) 2000 standard, which is described in further detail in Telecommunications Industry Association (“TIA”) standards IS-95A and IS-95B, which are both incorporated herein by reference in their entirety. CDMA is also described in the International Telecommunications Union (“ITU”) IMT-2000 series of standards, which are all incorporated herein by reference in their entirety. CDMA is further described in the TIA IS-2000 series of standards, which are all incorporated herein by reference in their entirety. The IS-2000 series of standards are commonly referred to as CDMA2000.

The rapid growth in the use of such techniques for accessing data networks has motivated the development of higher bandwidth network devices for providing such services. Additionally, rising infrastructure and operating costs associated with implementing and maintaining such networks (e.g., Mobile IP networks) has motivated the development of adaptable network devices and systems/platforms that may be employed in multiple applications and/or provide multiple functions concurrently. For example, the same network device may provide both packet data serving node (PDSN) functions and/or home agent (HA) functions in a Mobile IP network.

Furthermore, from a network reliability standpoint, it is desirable that the platforms used to implement network functions, such as PDSN or HA functions, employ a single network address (e.g., an IP address). Such an approach allows for multiple (e.g., redundant) devices (such as packet-processing cards capable of implementing PDSN and HA functions) to be associated with the single network address. In such an implementation, should one device fail, another (redundant) device can nearly seamlessly take its place and continue to provide network services without any perceptible service interruption from the user's perspective. Network devices implementing a single-IP address approach represent an improvement over previous approaches, such as approaches that used multiple network devices (e.g., PDSN or HA devices) each with a unique IP addresses and an individual network connection. Specifically, for example, the single-IP approach allows for a reduction in the number of network connections/cables and for the use of hardware redundancy, which results in a reduced number of possible failure points and a corresponding improvement in reliability.

One of these prior approaches is a so-called mid-plane based approach. In a mid-plane based approach, a low-speed signaling bus is used for system management. This bus may be termed a system management bus or a system control bus and these terms are used interchangeably in this disclosure. In such an approach, the individual network devices (e.g., PDSN or HA devices) in a single platform operate substantially independently of one another, with minimal or no interaction between them. In such implementations, each network device effectively operates as a stand-alone device. Therefore, such an approach typically uses one network address and one network cable per network device. The network devices may be, for example, individual cards implemented in a single system/platform frame or chassis. Use of such approaches was due, in part, to the limited data bandwidth available on a single network cable. The use of substantially stand-alone network devices operating in parallel was a way of increasing the overall available data bandwidth.

Improvements in data networking hardware (e.g., routers, servers, etc.) have lead to corresponding increases in the data bandwidth that is available over a single network connection. Network speeds of 1 gigabit per second on a single cable (1 gigabit=1×10⁹ bits) are currently readily available, with network speeds of 10 gigabits per second also becoming more readily available. Such increases in the data bandwidth available on a single network connection allow for the aggregation of data traffic onto fewer (or even a single) network cables and the use of a single-IP address approach. Additionally, use of a single or small number of network cables (e.g., two or three) with a platform providing PDSN and/or HA functions, allows for hardware redundancy and improved network reliability, as was discussed above.

Further, these increases in data bandwidth have allowed for alternative approaches for implementing network devices that provide, for example, PDSN functions and/or HA functions. One such approach is so-called backplane-based designs. Backplane-based systems/platforms typically include a high-speed backplane for communicating packet data from one packet-processing card to another in the same platform. One such network device is the Total Control 2000 (TC2K) available from UTStarcom, Inc., 1275 Harbor Bay Parkway, Alameda, Calif. 94502.

The TC2K system includes multiple wireless application cards (packet-processing cards) coupled, via a high speed-backplane, with a packet switch card. The packet switch card performs packet routing and forwarding functions in the TC2K system. Because the packet switch card is capable of routing packets to the individual wireless applications cards, the TC2K system is able to aggregate all of the data traffic for the system onto a single network address (e.g., and IP address) or a reduced number of IP addresses, depending on the particular implementation. Therefore, all of the application cards in the TC2K system may operate using the same IP address, or a number of IP addresses that is less than the total number of wireless application cards in the system. The packet switch routes packets to individual wireless application cards for processing based on the content of each packet.

For example, the packets may be routed based on a communication session identifier that is included in the header of each packet. After determining the communication session identifier from the packet, the packet switch determines the wireless application card associated with that specific communication session. The packet switch comparing the communication system identifier from the packet to a table associating communication session identifiers and wireless application cards can make this determination, for example.

This approach, however, may be problematic with respect to certain aspects of providing data network services, such as PDSN and/or HA services. For example, if data is routed to the TC2K system as encrypted packets (e.g., packets encrypted using the Internet Protocol Security (IPSEC) Protocol), it is not possible to determine the communication session identifier from the encrypted packet, because the communication session identifier is part of the encrypted payload of the packet. For example, the network address of the device that originally sent the packet (e.g., a mobile device) could be used as the communication session identifier.

The header of the encrypted packet (e.g., an Encapsulated Security Payload (ESP) header for an IPSEC encoded packet) typically contains the source and destination IP addresses for the network devices that terminate an IPSEC tunnel (e.g., a PDSN and HA). Additionally, the header of the encrypted packet may also include a sequence number for the packet in a clear (unencrypted) form, while the communication session identifier (e.g., the source address) and an ultimate destination address of the packet are included in the encrypted payload of the packet. The IPSEC Protocol is described in further detail in the Internet Engineering Task Force's (IETF's) Requests for Comments (RFCs) 2401, 2402 and 2406, which are incorporated by reference herein in their entirety.

Therefore, in such backplane-based systems (such as the TC2K system), the packet switch would need to decrypt an encrypted packet to determine its communication session identifier in order to identify which wireless application card in the system was responsible for processing the packet. Such an approach would put a huge processing burden on the packet switch and, as a result, would seriously affect data throughput through the packet switch and, therefore, the backplane-based system. Thus, alternative approaches for decrypting encrypted data packets in such network devices are desirable.

### SUMMARY

Methods and systems for processing encrypted data packets in a data network are disclosed. An exemplary method includes processing encrypted data packets in a distributed fashion. Such an approach overcomes the need to decrypt the packets with, for example, a packet switch device that is used for forwarding and routing of data packets in a network platform, as was discussed above. The exemplary method includes receiving an encrypted data packet at a packet switch device or card that is included in a network platform/system.

The packet switch card may receive the encrypted data packet directly (e.g., via a network interface included in the packet switch device). Alternatively, a first packet-processing card that is included in the network platform may receive the encrypted packet. In this situation, the first packet-processing device then communicates the encrypted data packet to the packet switch device. The packet-processing device (or card) may also be termed a wireless application card, and these terms are used interchangeably throughout this disclosure. Such packet-processing devices may be implemented using a combination of hardware, software and/or firmware, or using any other appropriate approach. In an exemplary network platform for providing PDSN and/or HA services, a plurality of packet-processing cards are included and are coupled with the packet switch card via a high-speed backplane.

After receiving the encrypted data packet, the packet-switch card determines a second packet-processing device in the network platform for decrypting the encrypted data packet (assuming the encrypted packet is received by a first packet-processing device). This determination is made using any number of techniques. For example, the packet switch may perform a hash function on a predetermined number of bits of a header of the encrypted data packet. Alternatively, this determination could be made based on a predetermined field of bits in the encrypted data packet header.

The method then includes communicating the encrypted data packet from the packet switch card to the second packet-processing device and decrypting the encrypted data packet with the second packet-processing device to produce a clear data packet. The second-packet processing device then communicates the clear data packet back to the packet switch card. After the packet switch card receives the clear data packet, processing of the packet (e.g., PDSN or HA processing) then continues in accordance with the network platform's architecture. Such distributed processing of encrypted data packets in a network platform (e.g., a backplane-based platform) that is providing Mobile IP services overcomes the adverse impact on system performance associated with a packet switch device (or the like) having to decrypt each encrypted data packet in order to determine which packet-processing card in the platform is responsible for processing the packet. Such an approach also allows for implementing a single-IP address approach.

It will be appreciated that any number of approaches are possible for communicating the encrypted data packet and the clear data packet (collectively “data packets”) within the network platform. For example, the data packets may be communicated between the packet switch card and the packet-processing card using the Multi Protocol Label Switching (MPLS) protocol. In such an approach, an MPLS header is included with each packet when it is communicated within the network platform. The MPLS protocol is described in further detail in the IETF's RFC 3031, which is incorporated by reference herein in its entirety. Of course, numerous other techniques for communicating packets within the network platform also exist. For example, User Datagram Protocol (UDP) headers could be used. As another alternative, encapsulation techniques such as Generic Route Encapsulation (GRE) or IP-in-IP could be used for communication within the network platform. Such techniques are known and will not be discussed in detail here.

A network platform/system for implementing the exemplary method described above (and other methods for processing encrypted data packets) includes a plurality of packet-processing cards, where at least one packet-processing card of the plurality includes a decryptor. The decryptor may be implemented as a hardware device implemented, in software and/or using firmware. Alternatively, the decryptor may be implemented using any other appropriate technique.

The network platform also includes a packet switch card. The packet switch card is operationally coupled with the plurality of packet-processing cards via a high-speed backplane. The packet switch card and the packet-processing cards communicate data packets between them via the high-speed backplane. The packet switch card and the packet-processing cards each include a programmable controller. These controllers include instructions that, when executed, collectively provide for implementing the method described above (or any other suitable method is for processing encrypted data packets).

These and other aspects will become apparent to those of ordinary skill in the art by reading the following detailed description, with reference, where appropriate, to the accompanying drawings. Further, it is to be understood that the embodiments noted in this summary are only examples and not intended to limit the scope of the invention as claimed.

### BRIEF DESCRIPTION OF THE DRAWINGS

Exemplary embodiments of the present invention are described herein with reference to the drawings, in which:

FIG. 1 is a diagram of a communication network that may employ the systems and methods shown in FIGS. 2-6;

FIGS. 2A and 2B are two diagrams illustrating a backplane-based network platform for providing packet data serving node and/or home agent services in a Mobile IP network;

FIG. 3 is a block diagram of a packet-processing card (e.g., wireless application card) of the platform shown in FIGS. 2A and 2B;

FIG. 4 is a block diagram of a packet switch card of the platform shown in FIGS. 2A and 2B;

FIGS. 5A-5D are diagrams illustrating data packets at various stages of processing with the platform of FIGS. 2A and 2B; and

FIG. 6 is a flowchart illustrating a method for processing encrypted data packets that may be implemented by the platform of FIGS. 2A and 2B.

### DETAILED DESCRIPTION

Embodiments of network platforms and methods for processing encrypted data packets are discussed generally in the context of wireless communication systems and packet data networks. However, it will be appreciated that the invention is not limited in this respect and that embodiments of the invention may be implemented in any number of types of communication systems, such as wired local area networks, and wired wide area networks, among any other type of appropriate data and/or communication network. As in most telecommunication and data applications, it will also be appreciated that many of the elements of the various embodiments described herein are functional entities that may be implemented as hardware, firmware and/or software or using any other appropriate technique. Additionally, many of the elements described in this disclosure may be implemented as discrete components or in conjunction with other components, in any suitable combination and location.

Organization of the Disclosure

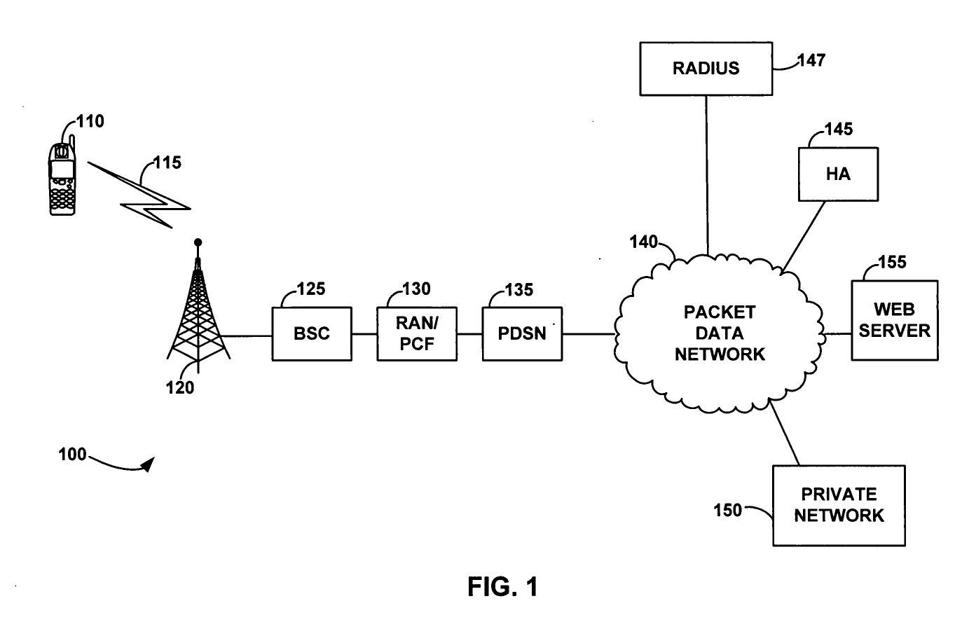

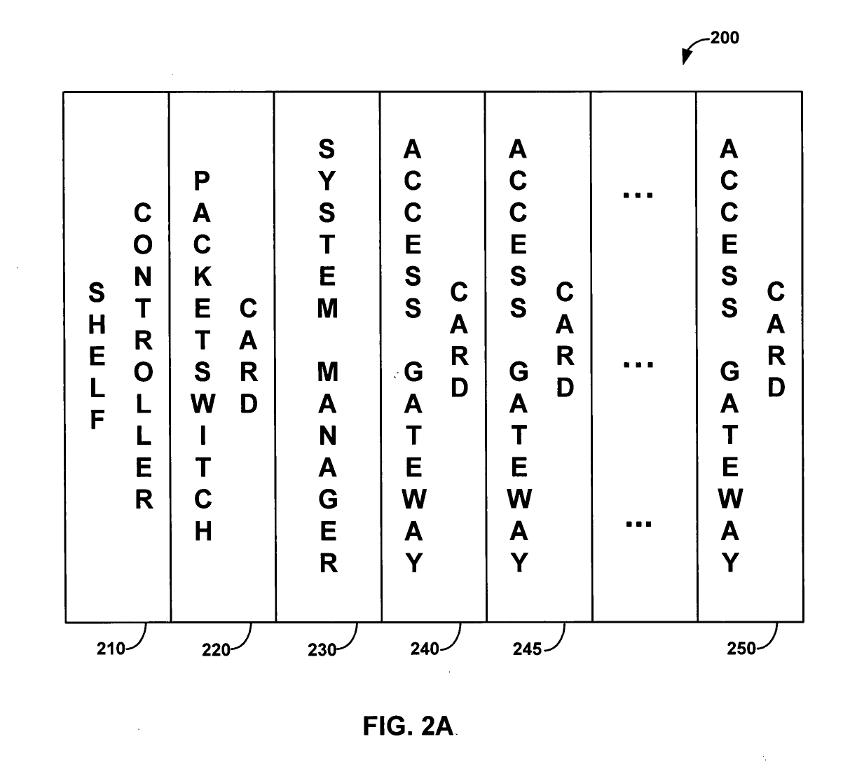

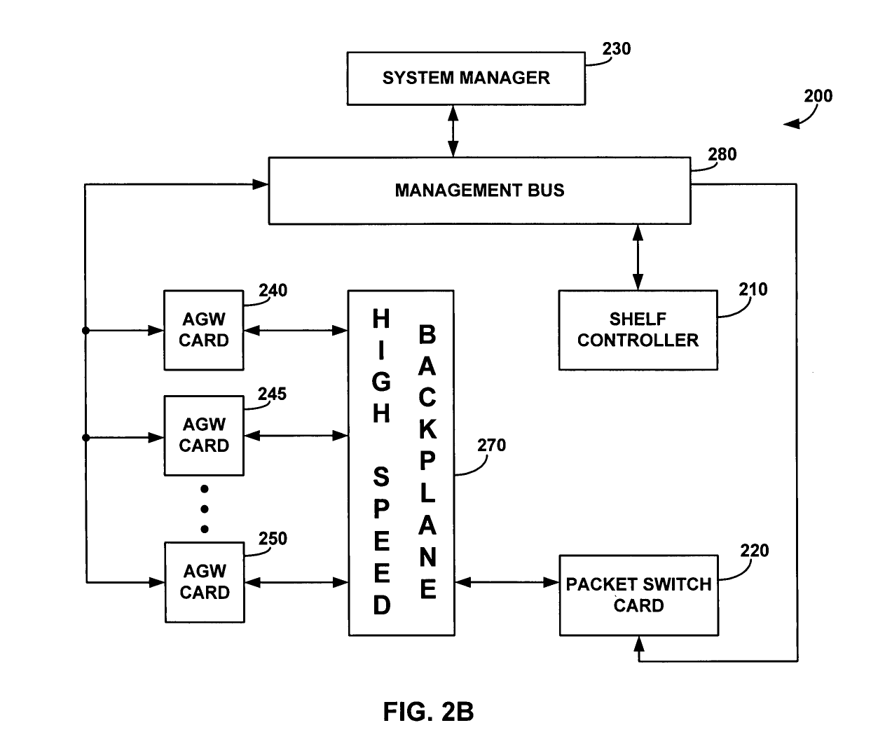

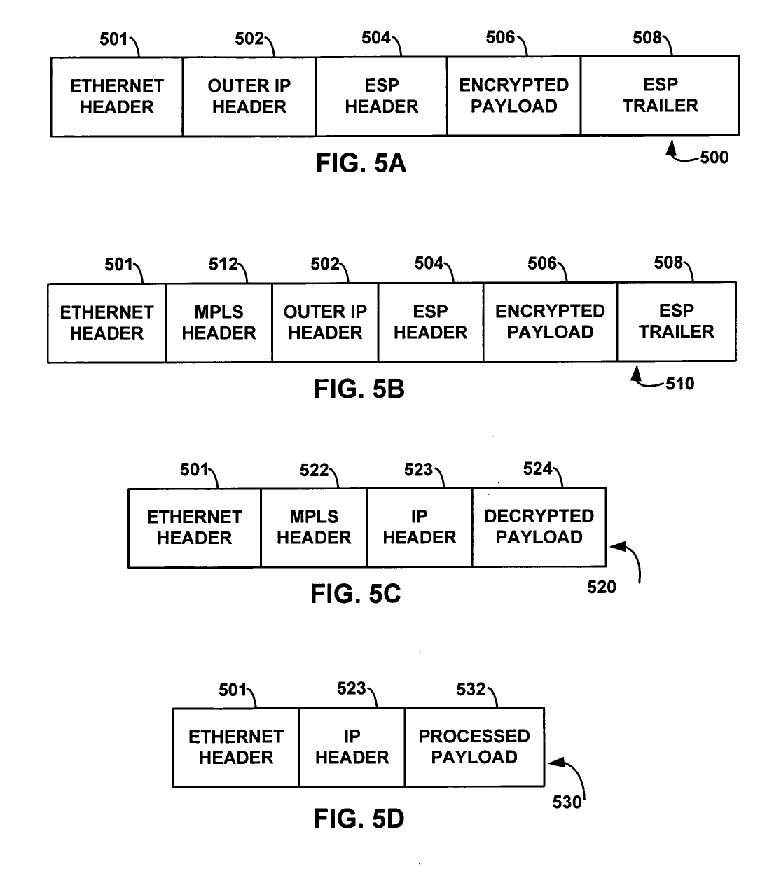

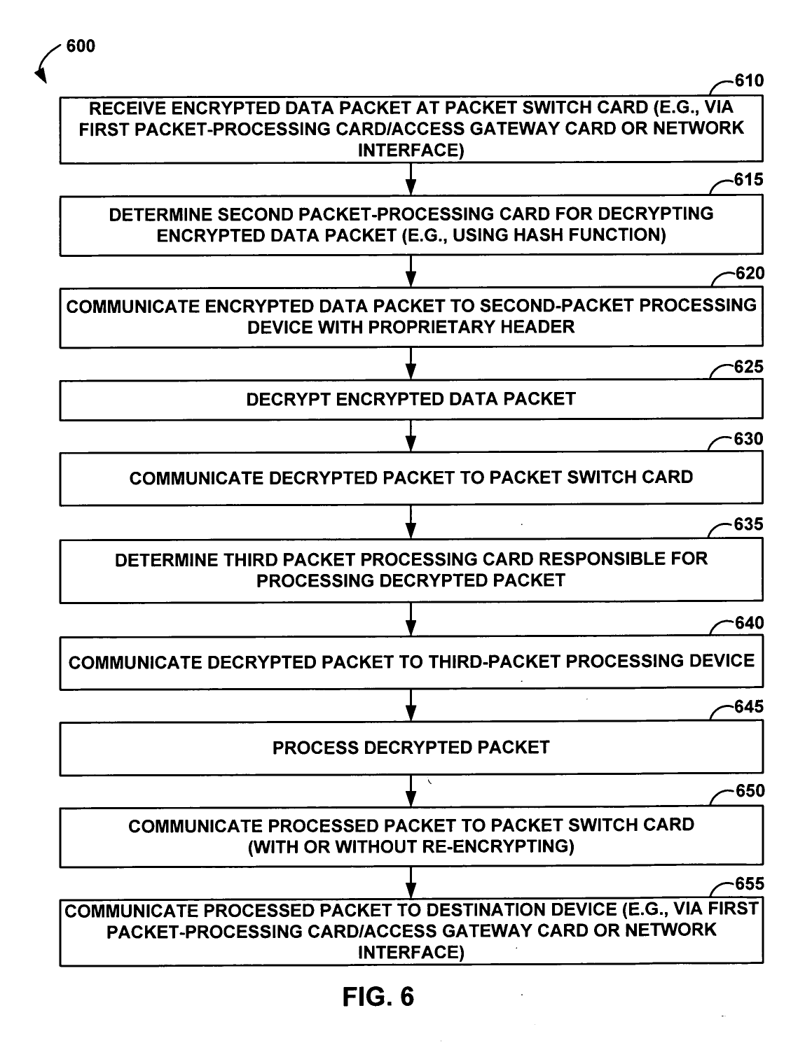

This disclosure is organized as follows. First, a packet data network in which encrypted data packets are processed is described with reference to FIG. 1. The network of FIG. 1 includes a wireless data network that implements the Mobile IP protocol in accordance with the CDMA2000 standard. Second, a backplane-based network platform is described with reference to FIGS. 2-4. The network platform is used in the system of FIG. 1 to provide packet data serving node and/or home agent services in the data network, and to process encrypted data packets in providing those services. Third, various data packet configurations are described with reference to FIGS. 5A-5D. The packet data configurations shown in FIGS. 5A-5D represent a single data packet at different stages of processing by the system shown in FIGS. 2A and 2B. Fourth, an exemplary method of processing an encrypted data packet, such as in the network platform of FIGS. 2A and 2B, is described with reference to FIG. 6.

Data Communications Network

FIG. 1 shows a data communication network 100 that is used for packet data communication. In network 100, a mobile station 110 is a wireless device, such as a wireless phone, a wireless personal digital assistant (PDA), a wireless enabled computer, or any other appropriate device that may be used in conjunction with a wireless communication network for data communications.

The mobile station 110 communicates with a radio network over an air interface 115. The radio network includes a base transceiver station (BTS) 120 that directly communicates with the client station 110 over the air interface 115 using radio frequency signals. The mobile station 110 may communicate with the BTS 120 using a variety of different protocols. For example, such communication may be accomplished using the CDMA2000 standard. Other wireless protocols may also be used. For example, the mobile station 110 and the BTS 120 may communicate using Wideband CDMA (WCDMA), Time Division-Synchronous CDMA (TD-SCDMA), Advanced Mobile Phone Service (AMPS), Digital AMPS (D-AMPS), Universal Mobile Telecommunications System (UMTS), Global System for Mobile Communication (GSM), IS-136, Time Division Multiple Access (TDMA), IEEE 802.11, Bluetooth (e.g., 802.15.1), MMDS, DECT, integrated digital enhanced network (IDEN), general packet radio service (GPRS) or other protocols.

The BTS 120 is coupled with a base station controller (BSC) 125. The BSC 125 is further coupled with a Radio Access Network/Packet Control Function Device 130, which in turn is coupled with a packet-data-serving node (PDSN) 135. The PDSN 135 then connects to a packet data network 140, such as the public Internet. These components and their operation are all described in further detail in the CDMA standards and will not be described in detail here for the purpose of brevity and clarity.

Using this connectivity, the mobile station 110 is then able to communicate with devices on the packet data network 140, as well as devices coupled with the packet network 140, such as a home agent 145, a Web server 155 and a private network 150, as some examples. The Web server 155, for example, provides the mobile station 110 access to the World Wide Web.

The data network of FIG. 1 also includes a Remote Authentication Dial-In User Service (RADIUS) sever 147 that is coupled with the packet network 140. As is known, the RADIUS server 147 (e.g., in cooperation with the PDSN 135 or the HA 145) authenticates users, authorizes access to private networks and collects information for the purposes of accounting and billing (such as user access time and charges). RADIUS servers and their role in data networks implementing the Mobile IP and CDMA standards are described in more detail in the TIA IS-835-C standard.

Data communications in the data network 100 may be accomplished using secure or unsecure communication sessions. When data communication is accomplished using a secure communication session, data packets are sent in encrypted format. For example, data packets sent as part of a secure communication session may be encrypted in accordance with the Internet Protocol Security (IPSEC) Protocol, as was described above. Of course, other encryption protocols may be used. Such protocols include Data Encryption Standard (DES) and Triple DES (3DES). However, for purposes of this disclosure, secure communication sessions will be described in the context of the IPSEC Protocol.

When establishing a secure communication session with the IPSEC Protocol, Internet Key Exchange (IKE) is used. IKE is described in more detail in the IETF's RFC 2409, which is incorporated by reference herein in its entirety. A security association is defined using IKE based on a security parameter index (SPI) that identifies the security association, a destination IP address and a key, which is a value used by the encryption and decryption algorithms to encrypt and decrypt the data packet payloads. This process is described in further detail in RFC 2409 and will not be discussed in detail here. Briefly, however, encryption and decryption of packets by the network entities that terminate an IPSEC tunnel (e.g., the two ends of the secure data communication tunnel) is done in accordance with the established security association for the particular IPSEC tunnel.

Of course, alternative approaches for establishing a security association may be used. For example, a security association could be statically defined using the IP addresses of the two IPSEC tunnel end points (e.g., a PDSN and an HA). As another alternative, for mobile-IP networks, a RADIUS server could establish the security association during authentication of a mobile device. Still, numerous other possible approaches for establishing a security association are possible.

As was described above, encrypted data packets communicated in the data network 100 and processed by the PDSN 135 and/or the HA 145 are decrypted in order to determine, for example, a communication session identifier from the decrypted packet payload. For IPSEC encrypted packets, this decryption is typically accomplished using an IPSEC hardware device, such as a Hifn 7851 security processor, which is available from Hifn, Inc., 750 University Avenue, Los Gatos, Calif. 95032.

As previously discussed, for backplane-based network platforms that employ a packet switch card, or the like (e.g., the UTStarcom TC2K platform), using the packet switch card to decrypt the encrypted packets for every secure communication session serviced by the platform can adversely affect the performance of the system. For example, if the HA 145 is dedicated to providing Virtual Private Network (VPN) services to the private network 150, substantially every packet processed by the HA 145 will be an encrypted packet. In such a situation, the performance of the HA 145 would be severely affected if its packet switch card were responsible for decrypting every encrypted packet the HA 145 received. Implementing a distributed approach for processing encrypted data packets in a backplane-based system significantly reduces this performance impact. Additionally, such an approach may more fully utilize the processing resources of the packet-processing (wireless application) cards included in such a network platform.

Backplane-Based Network Platform

FIGS. 2-4 illustrate a backplane-based network platform 200 that is used to provide PDSN and/or HA services in a Mobile IP compliant data communication network, such as the network 100 shown in FIG. 1. The platform 200 may be used to implement the PDSN 135 of FIG. 1 and/or the HA 145 of FIG. 1. Due to its backplane-based design, the platform 200 is able to provide both PDSN and HA services simultaneously. In such an application, for example, PDSN services are provided using a first IP address while HA services are provided using a second IP address.

1. Architecture

FIGS. 2A and 2B illustrate two different representations of a backplane-based network platform/system 200. FIG. 2A illustrates an exemplary chassis arrangement for a backplane-based network platform 200 for providing PDSN and/or HA services. The platform 200 is substantially similar to the UTStarcom TC2K wireless network platform. For purposes of this discussion, systems and methods for processing encrypted packets will be generally discussed in the context of the TC2K system.

The platform 200 includes a shelf controller card 210. While the platform 200 is illustrated with a single shelf controller 210, it will be appreciated that additional shelf controller cards may be implemented in the platform 200. For example, the UTStarcom TC2K platform includes two shelf controllers. The shelf controller provides hardware management for the platform 200 and provides low-speed Ethernet connectivity (e.g., 100 Mbps) between the components of the platform 200. For example, the shelf controller recognizes when a card (e.g., packet switch or packet-processing) is inserted or removed from the platform 200 and, accordingly, applies or removes power from the respective card slots. This functionality allows for the packet-processing and packet switch cards to be “hot-swapped” (e.g., removed and replaced while the system is in operation).

The platform 200 also includes a system manager card 230. As with the shelf controller card 210, the platform 200 is illustrated with a single system manager card 230. However, additional system manager cards may be included in the platform 200, such as for redundancy purposes. The system manager card 230 is coupled with a system management bus (not shown in FIG. 2A) and provides for configuring the components of the platform 200. For example, the system manager 230 is used to establish the type of service or services the platform 200 is to provide. Using the system manager 230, the platform 200 is configured to provide HA services, PDSN services or both. In the UTStarcom TC2K platform, system management is accomplished over a 100 mbps data bus (the system management bus) using the Simple Network Management Protocol (which is described in detail in the IETF's RFC 1157), as well as UTStarcom defined proprietary communication mechanisms. RFC 1157 is incorporated by reference herein in its entirety.

The platform 200 also includes a packet switch card 220. As with the shelf controller 210 and the system manager 230, the platform 200 is shown with a single packet switch card 200 for purposes of illustration. It will be appreciated that additional, redundant packet switch cards may be included in the platform 200. The TC2K system typically includes two packet switch cards.

The packet switch card 220 operates as a distribution point for data packets in the platform 200. Packets that are received by the packet switch card 220 are then routed or forwarded to a destination (e.g., for processing or egress from the platform 200). For packets being processed in the platform 200, the packet switch card 220 will examine each packet and communicate the individual packets to a respective access gateway (AGW) card of a plurality of AGW cards 240, 245 and 250 (packet-processing devices/cards or wireless application cards) based on this examination. As indicated by the dotted lines in FIG. 2A, the platform 200 may contain additional AGW cards. The AGW card to which a particular packet is routed depends on the type of packet and/or information contained in the packet headers, such as information contained in one or more of the Layer 2 to Layer 7 headers of Internet Protocol packets.

FIG. 2B illustrates the platform 200 in a block diagram. In FIG. 2B, the platform 200 further includes a high-speed backplane 270 and a system management bus 280. As is shown in FIG. 2B, the packet switch card 220 and the AGW cards 240, 245 and 250 are coupled with the backplane 270. The combination of the packet switch card 220 and the high-speed backplane 270 are referred to as a Media Data Bus (MDB) in the TC2K platform. The MDB is capable of handling gigabit Ethernet communication between the packet switch card 220 and the AGW cards 240-250. Packets being processed by the platform 200 are communicated via the MDB.

In FIG. 2B, the shelf controller card 210 and the system manager card 230 are coupled with the system management bus 280, while the management bus 280 is in turn coupled with each of the AGW cards 240-250, and the packet switch card 220. As was discussed above, shelf controller card 210 implements hardware management functions for the platform 200 and provides low-speed Ethernet connectivity (e.g., 100 Mbps) between the components of the platform 200. As also discussed above, the system manager 230, via the management bus 280, configures the platform 200 in accordance with the services the platform is to provide.

2. Access Gateway Card (Packet-processing Card)

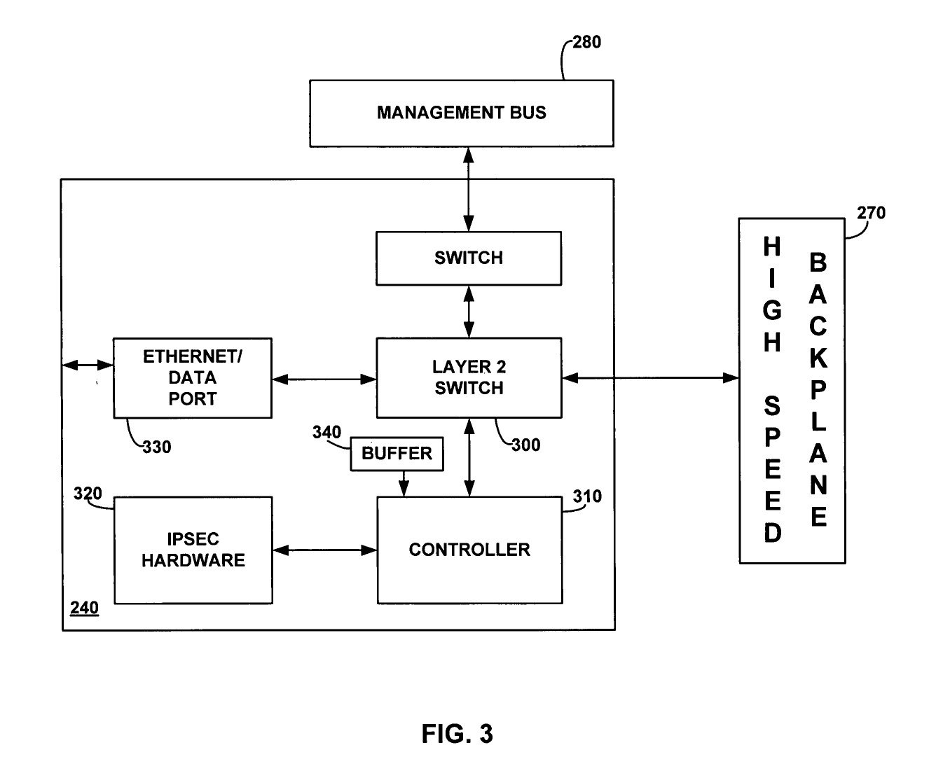

FIG. 3 illustrates the AGW Card 240 of the platform 200 in further detail. As shown in FIG. 3, the AGW card 240 is coupled with the high-speed backplane 270 and the management bus 280, as has been previously discussed. The AGW card 240 includes a Layer 2 (L2) Ethernet switch 300 that is coupled with the high-speed backplane 270. The L2 switch 300 receives packet data communicated to the AGW card 240 from the packet switch card 220 (via the backplane 270). Additionally, the L2 switch 300 communicates packet data that is being sent from the AGW card 240 to the packet switch card 220 onto the high-speed backplane 270. This communication is accomplished in accordance with any number of various data communication protocols, such as the IEEE 802.3 (Ethernet) standard, for example.

As was discussed above, decryption of encrypted data packets in the platform 200 is accomplished in a distributed fashion. For example, the packet-switch 220 sends the encrypted packets to the AGW cards of the platform 200 that are capable of decrypting those packets. Specifically, the packet switch 220 sends the encrypted packets to the AGW cards in the platform 200 that include a decryptor and are not dedicated to performing another function such as operating as a line card (e.g., functioning as a data conduit in and out of the system). When an encrypted packet is received at the L2 switch 300 of the AGW card 240, the L2 switch 300 communicates the packet to a controller 310 based on the header information of the encrypted packet. As an example, the packet switch card modifies the Ethernet header of the encrypted packet (e.g., by inserting an MPLS header) to indicate that the AGW card 240 is the intended destination of the encrypted packet.

After receiving the encrypted packet, the controller 310 examines the packet and determines that it is an encrypted packet (e.g., based on the MPLS label information in the Ethernet header and/or the ESP header and sequence number). The controller 310 then forwards the encrypted packet to an IPSEC hardware device 320, which decrypts the encrypted payload of the packet using the security association indicated in the ESP header of the encrypted packet, thus producing a clear data packet. The IPSEC hardware device 320 then returns the clear data packet to the controller 310. The controller 310 modifies the Ethernet header of the clear data packet to indicate that the packet switch card 220 is the destination of the clear data packet. Further, the controller 310 may also include some IPSEC related information in the modified header, such as a sequence number of the decrypted packet (e.g., in the MPLS labels that are part of the Ethernet Header). The controller 310 then sends the clear data packet to the L2 switch 300. The L2 switch 300 then communicates the clear data packet to the packet switch card 220 via the high-speed backplane 270.

A similar process occurs when the AGW card 240 receives a clear data packet for processing (e.g., PDSN or HA processing). The L2 switch 300 examines the Ethernet header of the clear data packet and determines that the AGW card 240 is the destination. Alternatively, another card in the platform 200 could receive the clear data packet for processing. The L2 switch of the AGW card 240 then sends the clear data packet to the controller 310, which processes the packet (e.g., performing Point-to-Point Protocol processing, as described in the IETF's RFCs 1661, 1662 or Generic Route Encapsulation Protocol processing, such as described in the IETF's RFC 2784) to produce a processed packet. The controller 310 then sends the processed packet to the L2 switch 300 to be communicated to the packet switch 220 via the backplane 270.

Alternatively, prior to sending the processed packet to the L2 switch 300, the controller 310 may send the processed packet to the IPSEC hardware device 320 to be re-encrypted in accordance with the IPSEC protocol. Such encryption would be done using a security association (SA) that is indicated by the session information (e.g. destination IP address) in the processed packet headers. After the packet is re-encrypted, it is sent to the packet switch card 220 via the controller 310, the L2 switch 300 and the backplane 270.

The AGW card 240 further includes an Ethernet port 330. The Ethernet port 330 may be coupled with an external network cable to allow the AGW card 240 to provide for data ingress and egress from the platform 200. In this situation, the AGW card 240 would function as a line card and may not provide any decryption or packet processing services in the in platform 200. In this situation, the L2 switch 300 effectively shunts the Ethernet port 330 with the high-speed backplane 270. As was noted above, all of the AGW cards (packet-processing cards) in the platform 200 may operate using a single-IP (network) address, with each AGW card being responsible for processing clear data packets associated with a specific, respective communication session or sessions.

The AGW card 240 additionally includes a packet buffer 340 that is coupled with the controller 310. The packet buffer 340 is used to buffer clear data packets at the AGW card 240 in the event those packets arrive at the AGW card 240 out of order. Clear data packets may arrive out of order because multiple AGW cards are used to decrypt encrypted packets that are associated with the same communication session and, depending on the loading of each of those AGW cards, may be transmitted to the AGW card 240 out of their original sequence. In the event this occurs, the buffer 340 holds the packets until a contiguous sequence of packets is present. The controller 310 then reorders the packets and processes them in sequence.

3. Packet Switch Card

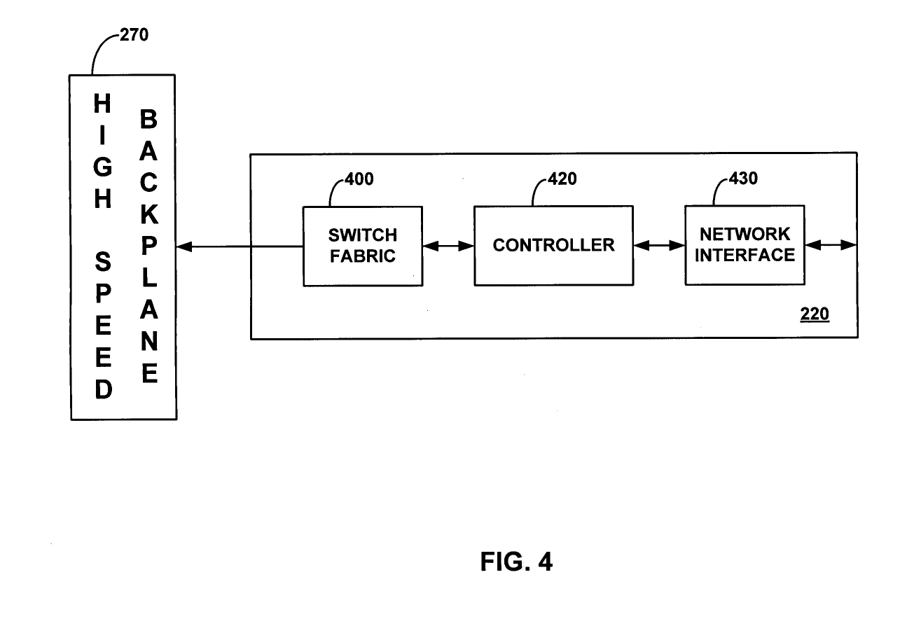

FIG. 4 illustrates the packet switch card 220 of the platform 200 in further detail. As is shown in FIG. 4, the packet switch card 220 is coupled with the high-speed backplane 270 via a switch fabric 400. As has been previously described, the packet switch card 220 communicates packet data with (to and from) the AGW cards of the platform 200 via the MDB (which includes the packet switch card 220 and the backplane 270). The switch fabric 400 may be implemented using one or more L2 switch components arranged in any suitable fashion in the packet switch card. The switch fabric 400 communicates, via the MDB, to receive and transmit packet data in the platform 200.

The packet switch card 220 further includes a programmable controller 420. The controller 420 may take the form of any appropriate instruction-processing device such as, but not limited to, a microcontroller, a microprocessor or a network processor. The controller 420 makes routing and forwarding decisions for data packets (encrypted and decrypted) received by the packet switch card 220.

The packet switch card 220 additionally includes a network interface 430 (e.g., an Ethernet port or optical data port) that may serve as a packet data ingress/egress point for the platform 200. Alternatively, data ingress/egress for the platform 200 is accomplished through one or more of the the AGW cards that are configured as line cards, as was discussed above. In either situation for the system 200, data packets entering the platform 200 are routed to the packet switch card 220. Once a data packet is received by the packet switch card 220, the packet is examined by the controller 420, which determines which AGW card of the platform 200 to route the packet to for processing.

When an encrypted data packet (an IPSEC compliant packet in this example) arrives at the packet switch card 220 (either via the network interface 430 or from an AGW card via the backplane 270), the packet headers are examined by the packet switch card 220 (e.g. by the controller 420). From this examination, the controller 420 determines that the packet is an incoming IPSEC packet based on the presence of an ESP header. The controller 420 then determines to which AGW card to send the IPSEC compliant packet. This determination is accomplished in a deterministic fashion, such as by calculating a hash function using a predetermined number of bits of the ESP header. As one example of a hash function, the modulus of the predetermined number of bits of the ESP header is determined using a prime number. Based on the result of this hash function, the controller sends the IPSEC compliant packet to an AGW card that is pre-associated with the result. Using a deterministic approach for determining which AGW card to send IPSEC compliant packets to (or any encrypted packet) is desirable. Specifically, such deterministic approaches ensure that any duplicate IPSEC packets are sent to the same AGW card, so that those duplicate packets are handled by the AGW card in accordance with the IETF's RFC 2406 requirements for handling duplicate packets.

When sending the IPSEC encrypted packet to the appropriate AGW card, the packet switch card 220 inserts a proprietary header in the packet headers to indicate that it is the source of the packet and that the respective AGW card is the destination. As was discussed above, this header may be an MPLS header or another header in accordance with any other appropriate protocol such as UDP, GRE or IP-in-IP, among numerous other protocols.

After the AGW card decrypts the IPSEC compliant packet, the decrypted packet is returned to the packet switch card 220 (via the MDB) as a clear data packet. The packet switch card 220 then examines the clear data packet's headers (e.g. using the controller 420) to determine, for example, a communication session identifier for a communication session with which the clear data packet is associated. The controller 420 then determines which AGW card of the platform 200 is responsible for processing packets for the determined communication session. This determination may be made by consulting a table that associates communication sessions that the platform 200 is servicing with the respective AGW cards responsible for those sessions. Such a table may be stored and maintained in the controller 420, for example. Alternatively, a list of the communication sessions and their associated AGW cards may be stored in a separate component in the packet switch card 220, such as in a memory device (not shown) coupled with the controller 420. It will be appreciated that other information in the clear data packet's headers may be used to determine which AGW card is responsible for processing the packet.

After determining which AGW card is responsible for processing the clear data packet, the packet switch 220 forwards the clear data packet to that AGW card for processing (e.g., HA or PDSN processing). Once the processing of the packet is complete, the packet switch 220 receives either a processed packet or a re-encrypted packet. Based on an examination of the header of the processed or re-encrypted packet, the packet switch 220 determines that the processing of the packet is complete and strips out any remaining MPLS headers and/or labels that were inserted during processing. The packet switch 220 then modifies the Ethernet header appropriately and routes the packet (processed or re-encrypted) to the destination address indicated in the headers (e.g., via the network interface or via an AGW card, depending on the particular embodiment).

Data Packet Forms during Processing

As will be appreciated from the foregoing, a data packet takes various forms during processing by the platform 200 (or in any platform implementing a distributed packet decryption technique). FIGS. 5A-5D illustrate some example packet configurations for a packet being processed by the platform 200.

FIG. 5A illustrates a data packet 500 encrypted in accordance with the IPSEC protocol. The packet 500 includes an Ethernet header 501 and an outer IP header 502, which indicate the source of the packet and the destination of the encrypted packet (in this case, the platform 200, at least as an intermediate destination). The packet 500 also includes an IPSEC compliant ESP header 504, which contains a sequence number, an encrypted payload 506 and an ESP trailer 508, in accordance with the IPSEC protocol. The packet 500 is exemplary of an encrypted packet that is received by the platform 200 from an external device, such as at the HA 145 from the private network 150 in the data network of FIG. 1. The packet switch 220 then inserts an MPLS header 512 in the packet 500 to produce the packet 510. The packet 510 is then routed to an AGW card for decryption, such as in the fashion described above. The other portions of the packet 500 remain the same in the packet 512.

The AGW card decrypts the encrypted payload 506 of the packet 510 to produce a clear data packet 520. The clear data packet 520 includes the Ethernet header 501, a new or modified MPLS header 522 for routing the packet 520 back to the packet switch card 220, an IP header 523, which was previously part of the encrypted payload 506, and a decrypted payload 524. As was previously discussed, this decryption is accomplished in accordance with the IPSEC protocol using a security association that has been established using IKE.

As was also described above, after receiving the clear data packet 520, the packet switch card 220 examines the decrypted payload 524 to determine, for example, the communication session with which the packet is associated (e.g., the source IP address of the clear packet). The packet switch 220 then routes the packet 520 to the appropriate AGW card for processing with another modified MPLS header 522. After the AGW card completes processing of the clear data packet, it sends a processed packet (not shown) back to the packet switch card 220 and then the packet switch card 220 strips off any remaining proprietary (e.g., MPLS in this example) headers to produce a final packet 530. The final packet 530 includes the Ethernet header, the IP header 523 and a processed payload 532. The final packet 530 is then routed to a destination device (or a next destination device), in accordance with the Ethernet header 501 and/or the IP header 523. Alternatively, the final packet could be re-encrypted by an AGW card of the platform 200 and sent to its next destination in the same form as the encrypted packet 500 of FIG. 5A.

Method for Processing Encrypted Data Packets

FIG. 6 illustrates a method 600 for processing encrypted data packets, such as those encrypted with the IPSEC protocol. The method may be implemented in the platform 200 using the techniques described above. The method 600 includes, at block 610, receiving an encrypted data packet at a packet switch card. The encrypted data packet may be received, for example, via a first packet-processing card (e.g., an AGW card operating as a line card) and a high speed bus in a network platform including both the packet switch card and the first packet processing card (e.g., a TC2K platform) or, alternatively, via a network interface included on the packet switch card.

At block 615, the method 600 includes determining a second packet-processing card for decrypting the encrypted packet, such as by using a hash function, as discussed above. The encrypted packet is forwarded to the second packet-processing card at block 620, and is decrypted by the second packet-processing device at block 625 to produce a clear data packet.

The second packet-processing card communicates the clear data packet back to the packet switch card at block 630. At block 635, the packet switch card then determines a third packet processing card for processing the packet (e.g., performing PDSN or HA services) by determining a communication session with which the packet is associated and communicates the clear data packet to the third packet processing card at block 640. The third packet-processing card then processes the packet (e.g., performing HA, PDSN and/or VPN services) at block 645 to produce a processed packet.

Depending on the particular situation, at block 650, the third packet-processing device communicates the processed packet directly back to the packet switch or, alternatively, re-encrypts the packet in accordance with a security association identified in the packet or based on the communication session with which the packet corresponds. The processed or re-encrypted packet is then communicated to the packet switch. At block 655, the packet switch communicates the processed packet or re-encrypted packet to a destination device, either via its network interface or through the first packet-processing device, such as in the fashion described above. In another alternative, the third packet-processing device may communicate the processed packet back to the packet switch and the packet switch may then send the processed packet to another packet processing-device (e.g., the second packet-processing device or a fourth packet-processing device) to be re-encrypted. The re-encrypted packet is then sent back to the packet switch and the packet switch routes the re-encrypted packet to its destination (e.g., such as indicated in a new ESP header for an IPSEC compliant packet).

### CONCLUSION

Various arrangements and embodiments have been described herein. It will be appreciated, however, that those skilled in the art will understand that changes and modifications may be made to these arrangements and embodiments without departing from the true scope and spirit of the present invention, which is defined by the following claims.

What is claimed is:

1. A method of processing encrypted data packets in a data network, the method comprising:
receiving an encrypted data packet at a packet switch module;
with the packet switch, determining a first packet-processing device for decrypting the encrypted data packet;
communicating the encrypted data packet from the packet switch to the first packet-processing device;
decrypting the encrypted data packet with the first packet-processing device to produce a clear data packet;
communicating the clear data packet from the first packet-processing device to the packet switch.

2. The method of claim 1, further comprising:
with the packet switch, determining a second packet-processing device responsible for a communication session associated with the clear data packet;
communicating the clear data packet from the packet switch to the second packet-processing device; and
processing the clear data packet with the second packet-processing device to generate a processed packet.

3. The method of claim 2, wherein determining the second packet-processing device responsible for the communication session associated with the clear data packet comprises:
analyzing a header of the clear data packet to determine a communication session identifier for the communication session associated with the clear data packet; and
determining from the communication system identifier that the second packet-processing device is hosting the communication session associated with the clear data packet.

4. The method of claim 2, further comprising:
buffering the clear data packet in a packet buffer on the second packet processing device prior to processing the clear data packet, the clear data packet being buffered in the packet buffer along with at least one other clear data packet; and
in the event the clear data packet and the at least one other clear data packet arrive at the second packet-processing device out of order, reordering the clear data packet and the at least one other clear data packet in the packet buffer prior to processing the clear data packet.

5. The method of claim 2, wherein processing the clear data packet comprises processing the clear data packet according to the Point-to-Point Protocol.

6. The method of claim 5, wherein processing the clear data packet further comprises processing the clear data packet according to the Generic Route Encapsulation Protocol.

7. The method of claim 2, wherein processing the clear data packet comprises performing packet-switch-data-serving node processing on the clear data packet.

8. The method of claim 2, wherein processing the clear data packet comprises performing home agent processing on the clear data packet.

9. The method of claim 2, further comprising:
encrypting the processed packet with the second packet-processing device to generate a re-encrypted packet;
communicating the re-encrypted packet from the second packet-processing device to the packet switch; and
communicating the re-encrypted packet to a destination device for the re-encrypted packet.

10. The method of claim 2, further comprising communicating the processed packet from the second packet-processing device to the packet switch; and
communicating the processed packet to a destination device.

11. The method of claim 10, wherein communicating the packet to a destination device for the processed packet comprises:
communicating the processed packet from the packet switch to a third packet processing device; and
communicating the processed packet to the destination device from the third packet-processing device.

12. The method of claim 2, further comprising:
communicating the processed packet from the second packet-processing device to the packet switch,
with the packet switch, determining a third packet-processing device for re-encrypting the packet;
communicating the processed packet from the packet switch to the third packet-processing device;
encrypting the processed packet with the third packet-processing device to generate a re-encrypted packet;
communicating the re-encrypted packet from the third packet-processing device to the packet switch; and
communicating the re-encrypted packet from the packet switch to a destination device for the re-encrypted packet.

13. The method of claim 12, wherein the first and third packet-processing devices comprise a same packet packet-processing device.

14. The method of claim 2, wherein the first and second packet-processing devices comprise separate packet-processing devices.

15. The method of claim 2, wherein the first and second packet-processing devices comprise a same packet-processing device.

16. The method of claim 1, wherein determining the first packet-processing device for decrypting the encrypted data packet with the packet switch comprises:
solving a hash function using a predetermined number of bits of an Encrypted Security Payload header of the encrypted packet to produce a hash function result;
determining the first packet-processing device for decrypting the encrypted data packet based on the hash function result, wherein the first packet-processing device is selected from a plurality of packet processing devices.

17. The method of claim 1, wherein decrypting the encrypted data packet with the first packet-processing device to produce a clear data packet comprises decrypting the encrypted packet according to the Internet Protocol Security Protocol.

18. The method of claim 1, wherein receiving the encrypted data packet at the packet switch comprises:
receiving the encrypted data packet at a second packet processing device operationally coupled with the packet switch; and
communicating the encrypted data packet from the second packet-processing device to the packet switch.

19. A method of processing encrypted data packets comprising:
receiving an encrypted data packet at a first packet-processing device via a communication channel;
communicating the encrypted data packet from the first packet-processing device to a packet switch;
using the packet switch, determining a second packet-processing device for decrypting the encrypted data packet;
communicating the encrypted data packet from the packet switch to the second packet-processing device;
decrypting the encrypted data packet with the second packet-processing device to produce a clear data packet;
communicating the clear data packet to the packet switch.

20. The method of claim 19, further comprising:
with the packet switch, determining a third packet-processing device responsible for a communication session associated with the clear data packet;
communicating the clear data packet from the packet switch to the third packet-processing device; and
processing the clear data packet with the third packet-processing device to generate a processed packet.

21. The method of claim 20, further comprising:
encrypting the processed packet with the third packet-processing device to generate a completed packet;
communicating the completed packet from the third packet-processing device to the packet switch;
communicating the completed packet from the packet switch to the first packet-processing device; and
communicating the completed packet from the first packet-processing device to a destination device via the communication channel.

22. The method of claim 20, further comprising:
communicating the processed packet from the third packet-processing device to the packet switch;
communicating the processed packet from the packet switch to the first packet-processing device; and
communicating the completed packet from the first packet-processing device to a destination device via the communication channel.

23. The method of claim 20, wherein the first, second and third packet-processing devices comprise three separate packet processing devices.

24. The method of claim 20, wherein the second and third packet processing devices comprise the same packet-processing device.

25. A network platform for processing data packets comprising:
a plurality of packet-processing cards, at least one packet-processing card including a decryptor;
a packet switch card operationally coupled with the plurality of packet-processing cards; and
a high-speed backplane for communicating data packets between the packet switch and the plurality of packet-processing cards;
wherein the packet switch card and the plurality of packet-processing cards include machine executable instructions that, when executed, collectively provide for:
receiving an encrypted data packet at the packet switch;
with the packet switch, determining a first packet-processing card of the at least one packet-processing cards including a decryptor for decrypting the encrypted data packet;
communicating the encrypted data packet from the packet switch to the first packet-processing card via the high-speed back plane;
decrypting the encrypted data packet with the decryptor of the first packet-processing card to produce a clear data packet;
communicating the clear data packet from the first packet-processing card to the packet switch via the high-speed backplane.

26. The network platform of claim 25, wherein the instructions, when executed, further provide for:
determining a second packet-processing device responsible for a communication session associated with the clear data packet;
communicating the clear data packet from the packet switch to the second packet-processing device via the high-speed backplane; and
processing the clear data packet with the second packet-processing device to generate a processed packet.

27. The network platform of claim 26, wherein the instructions, when executed, further provide for:
encrypting the processed packet with the second packet-processing device to generate a re-encrypted packet;
communicating the re-encrypted packet from the second packet-processing device to the packet switch via the high speed backplane; and
communicating the re-encrypted packet to a destination device for the re-encrypted packet.

28. The network platform of claim 26, wherein the instructions, when executed, further provide for:
communicating the processed packet from the second packet-processing device to the packet switch via the high-speed backplane; and
communicating the processed packet to a destination device.

29. The network platform of claim 25, wherein each packet-processing card of the plurality of packet processing cards includes service logic to provide:
packet data serving node functions; and
home agent functions.

30. The network platform of claim 25, wherein each of the packet-processing cards includes:
a data port receiving packet data from an external network platform;
a data switch coupled with the data port and the high-speed backplane; and
a programmable controller coupled with the switch,
wherein the data switch selectively routes packet data to and from:
the data port and the high-speed backplane;
the controller and the high-speed back plane; and
the data port and the controller.

31. The network platform of claim 30, wherein the data switch comprises a Layer 2 Ethernet Protocol switch.

32. The network platform of claim 30, further comprising a system management bus coupled with the data switch, wherein the data switch selectively routes system management data to and from the network processor.

33. The network platform of claim 25, wherein the packet switch card comprises:
a data port coupled with the high-speed backplane;
a data switch coupled with the data port; and
a programmable network processor coupled with the data switch.
